(19) United States
(12) Patent Application Publication
(10) Pub. No.: US 2015/0129377 A1
(43) Pub. Date: May 14, 2015

(54) METHOD TO INCREASE CORROSION RESISTANCE IN FERRITIC NITROCARBURIZED TREATED CAST IRON SUBSTRATES

(71) Applicant: GM Global Technology Operations LLC, Detroit, MI (US)

(72) Inventors: Michael D. Hanna, West Bloomfield, MI (US); Michael L. Holly, St. Clair Shores, MI (US)

(21) Appl. No.: 14/601,714

(22) Filed: Jan. 21, 2015

Related U.S. Application Data
(63) Continuation of application No. 12/574,940, filed on Oct. 7, 2009.

(51) Int. Cl. F16D 65/12; C23C 8/32; F16D 69/02

(52) U.S. Cl. CPC F16D 65/127; F16D 69/027; C23C 8/32
USPC 188/218 XL; 148/212

(57) ABSTRACT

A method for improving corrosion resistance in FNC cast iron substrates without the need for additional coating or painting. The exemplary methods remove a portion of the FNC coating applied to a cast iron substrate, preferably through polishing, to expose the epsilon phase portion of the compound area. The epsilon phase portion is thought to provide improved corrosion protection as compared to non-polished FNC cast iron substrates. One exemplary product that may be provided with improved corrosion protection according to the above method is a brake rotor having a FNC treatment.

### CROSS-REFERENCE TO RELATED APPLICATIONS

This application is a continuation of U.S. application Ser. No. 12/574,940 filed Oct. 7, 2009.

### TECHNICAL FIELD

The field to which the disclosure generally relates to methods for making ferritic nitrocarburized cast iron substrates more corrosion resistant.

### BACKGROUND

Motor vehicle disc brake systems utilize a disc brake rotor at each respective wheel, wherein the disc brake rotor typically includes a rotor hat for connecting to an axle hub of a rotatable axle of the motor vehicle, and at least one annular rotor cheek connected to the rotor hat, wherein the at least one rotor cheek has a pair of mutually opposed braking surfaces onto which brake pads are selectively applied when braking is desired.

Typically, brake rotors are either made solid or are provided with internal ventilation. There are usually cast from iron-based alloys and especially cast iron such as grey cast iron a (G3000) and damped cast iron (G1800). Cast iron rotors are casted to near shape and machined to shape after casting. The disadvantage of cast iron rotors is that they exhibit insufficient corrosion resistance compared to other conventional materials. Winter climate and using the salt on roads can make the situation worse.

To remedy corrosion issues with cast iron rotors, a ferritic nitrocarburizing (FNC) method to prevent the friction surface from corrosion during operation has been developed. However, the as-received FNC surface on non-frictional surface may still be prone to corrosion after exposure to a humid atmosphere.

### SUMMARY OF EXEMPLARY EMBODIMENTS OF THE INVENTION

The exemplary embodiments provide a method for improving corrosion resistance in FNC cast iron substrates without the need for additional coating or painting. The exemplary methods remove a portion of the FNC coating applied to a cast iron substrate, preferably through polishing, to expose the epsilon phase portion of the compound area. The epsilon phase portion is thought to provide improved corrosion protection as compared to non-polished FNC cast iron substrates.

One exemplary product that may be provided with improved corrosion protection according to the above method is a brake rotor having a FNC treatment.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 illustrates a perspective view of a brake rotor according to one exemplary embodiment;

FIG. 2 is a section microscopic view illustrating the ferritic nitrocarburized treatment applied to a portion of the brake rotor as in FIG. 1; and

FIG. 3 is a section microscopic view of a portion of the brake rotor of FIG. 2 with a portion of the ferritic nitrocarburized treatment removed in accordance with an exemplary embodiment.

### DETAILED DESCRIPTION OF EXEMPLARY EMBODIMENTS

The following description of the embodiment(s) is merely exemplary (illustrative) in nature and is in no way intended to limit the invention, its application, or uses.

The exemplary embodiments provide a method for improving corrosion resistance on cast iron substrates that include a ferritic nitrocarburized (FNC) surface treatment. Two specific exemplary products having FNC treated cast iron substrates include solid and vented brake rotors.

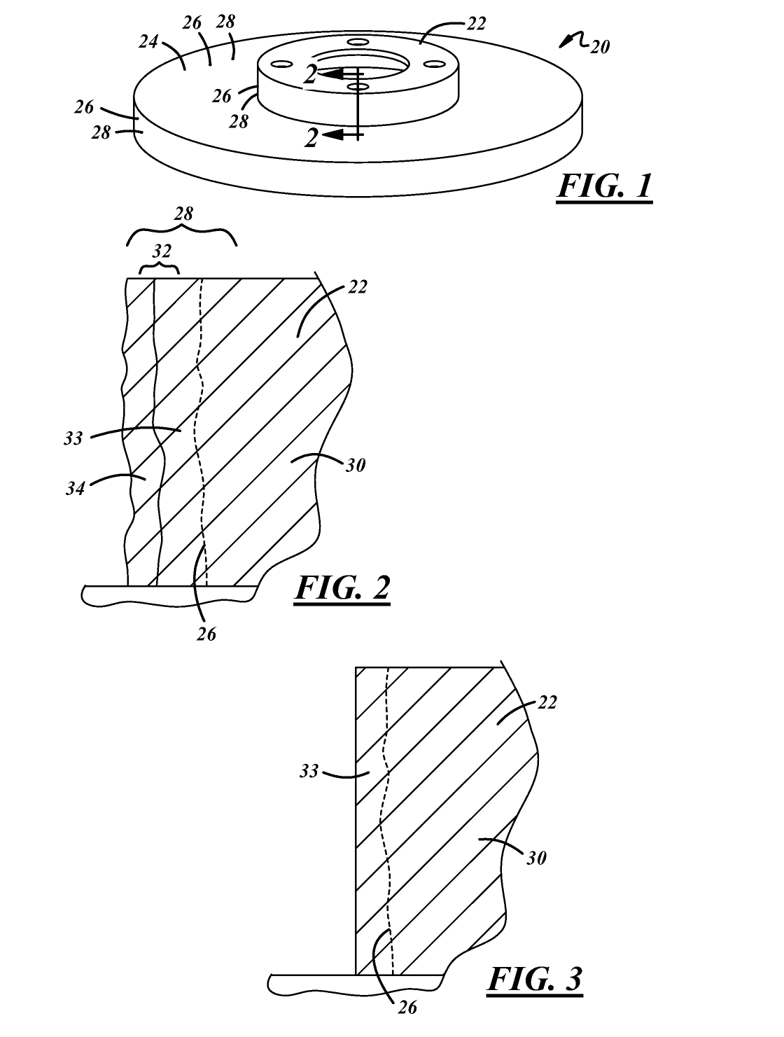

Referring now to FIG. 1, a brake rotor 20 may be illustrated according to one exemplary embodiment as having a hat portion 22 with a rotor cheek 24 extending about the periphery thereof. The rotor cheek 24 may be generally referred to as a friction surface of the rotor 20 that engages the caliper and other brake parts to slow a vehicle during use, while the hat portion 22 may be generally referred to as a non-frictional surface that does not participate in the slowing of a vehicle through frictional engagement and disengagement.

The shape of the brake rotor 20 as illustrated, and specifically the respective shapes and relative dimensions of the hat 22 and rotor cheek 24, are but one specific example of a potentially infinite variety of possibilities or shapes and dimensions of brake rotors and are thus not limited as illustrated in FIG. 1.

The brake rotor 20 may be formed from an iron-based alloy or steel, and especially cast iron such as grey cast iron a (G3000) and damped cast iron (G1800).

A surface treatment 28 may be applied to the outer surface 26 of brake rotor 20 and provides the outer surface 26 with a degree of friction resistance and with a degree of corrosion resistance.

In the exemplary embodiment as shown in FIGS. 1 and 2, the surface treatment 28 may be a ferritic nitrocarburized (FNC) coating 28 applied to a depth of between 10 and 20 microns extending from the outer surface 26, and more preferably about 15 microns. The ferritic nitrocarburizing surface treatment 28 may enhance surface hardness and corrosion resistance in the brake rotor 20, as well as providing increased friction for portions of the rotor 20 that engage the caliper and other brake parts, including the rotor cheek 24, to aid in slowing the vehicle to which they are applied.

The process for applying the FNC surface treatment 28 may be carried out at temperatures between about 525 and 650 degrees Celsius (975 and 1200 degrees Fahrenheit); the preferred process temperature may be approximately 565 degrees Celsius (1050 degrees Fahrenheit) to achieve the desired coating of about 10 to 20 microns.

Upon application, as best shown in FIG. 2, a portion of the FNC coating 28 may diffuse into the outer surface 26 of the brake rotor 20 to form a diffusion layer 30, while the remaining portion of the FNC coating 28 above the surface 26 may be referred to as the compound layer 32. The compound layer 32, as stated above, may preferably have a depth of between 10 and 20 microns, and more preferably about 15 microns, extending from the outer surface 26.

The diffusion layer 30 may contain a mix of the phases, including epsilon-Fe2-3(N,C) (the “epsilon phase” or “hexagonal phase”) and gamma-prime Fe4(N,C) (the “gamma phase”) and a ferrite phase that results from details of the process parameters such as temperature, heat treatment time, and gas composition and pressure. As shown in FIG. 2, the ferrite phase may become more predominant further away from the compound layer 32 and outer surface 26.

The compound layer 32 may also contain a specific mix of the phases, including the epsilon phase, the gamma phase, and a ferrite phase that results from details of the process parameters such as temperature, heat treatment time, and gas composition and pressure.

The compound layer 32 may further be characterized as having an inner portion 33 closer to the outer surface 26 of the hat 22 (and diffusion area 30), and an outer surface portion 34.

The inner portion 33 may be considered substantially in the epsilon phase, also known as the dominant epsilon phase portion 33. The outer surface portion 34 may contain a mix of the gamma phase, epsilon phase as well as oxides such as Fe₃O₄.

Next, as best shown in FIG. 3, the hat 22, or other non-frictional surfaces of the brake rotor 20 (not shown), may be treated to remove the outer surface portion 34 and expose the underlying inner portion 33 of the compound area 32. More specifically, the treatment removes enough of the outer surface portion 34 of the compound layer 32 to expose the dominant epsilon phase portion 33 there within. In one exemplary embodiment, for a surface treatment 28 in which the total compound layer 32 depth is between about 10 and 20 microns, the treatment may remove about 2 and 6 microns of the outer surface portion 34 to expose the interior portion 33.

The exposure to the epsilon phase portion 33 is believed to provide improved corrosion resistance to the non-frictional surfaces of the brake rotor 20 as compared with a non-polished surface treatment (i.e. where the outer surface portion 34 remains intact and may include primarily the gamma phase and oxides are described above).

In one exemplary embodiment, the treatment may consist of grinding, conditioning or polishing, preferably with a diamond paste of 1 micron particles, of the outer coating surface 34 inward to a depth of between about 2 and 6 microns to expose the dominant epsilon phase 33 portion of the compound area 32. Experimental testing of rotors 20 according to this treatment confirm that samples having the exposed dominant epsilon phase portion 33 in the hat 22 exhibited less corrosion compared to the rotors 20 in which the outer coating 34 within the hat 22 remained unpolished.

While the above method for improving the corrosion resistance was specifically discussed with respect to brake rotors 20 in the exemplary embodiments as described above, a similar improvement in corrosion resistance may be expected in any cast iron substrate in which an FNC surface treatment has been utilized. Thus, the exemplary method for improving corrosion resistance may be equally applicable to any FNC treated cast iron substrate.

The above description of embodiments of the invention is merely exemplary in nature and, thus, variations thereof are not to be regarded as a departure from the spirit and scope of the invention.

What is claimed is:

1. A brake rotor comprising a ferritic nitrocarburized coating extending from the outer surface of the brake rotor cheek.

2. A brake rotor as set forth in claim 1 wherein a portion of the coating includes a diffusion layer, and a portion of the coating including a compound layer.

3. A brake rotor as set forth in claim 2 wherein the compound layer has a depth of between 10 and 20 microns.

4. A brake rotor as set forth in claim 2 wherein the compound layer has a depth of about 15 microns, extending from an outer surface of a brake rotor cheek.

5. A brake rotor as set forth in claim 2 wherein the diffusion layer 30 includes an epsilon-Fe2-3(N,C) epsilon phase, a gamma-prime Fe4(N,C) phase, and a ferrite phase.

6. A brake rotor as set forth in claim 1 wherein ferritic nitrocarburized coating comprises a diffusion layer extending from an outer surface of a brake rotor cheek, and a compound layer underneath the diffusion layer, the compound having an inner portion closer to the outer surface, and an outer surface portion underneath the inner portion.

7. A method comprising ferritic nitrocarburizing a brake rotor cheek to enhance surface hardness and corrosion resistance in the brake rotor cheek.

8. A method as set forth in claim 7 wherein the ferritic nitrocarburizing at a temperature ranging between about 525 and 650 degrees Celsius

9. A method as set forth in claim 7 wherein the ferritic nitrocarburizing at a temperature of approximately 565 degrees Celsius.

10. A method as set forth in claim 7 wherein the ferritic nitrocarburizing is carried out to achieve a coating of about 10 to 20 microns.
